(19) United States
(12) Patent Application Publication
(10) Pub. No.: US 2024/0330983 A1
(43) Pub. Date: Oct. 3, 2024

(54) Automatic Proximity Based Searches and Reminders of Items of Interest

(71) Applicant: International Business Machines Corporation, Armonk, NY (US)

(72) Inventors: Frank Isaacs, Wake Forest, NC (US); Randy A. Rendahl, Raleigh, NC (US); Ashley Kristin Silva, Durham, NC (US)

(21) Appl. No.: 18/127,187

(22) Filed: Mar. 28, 2023

(51) Int. Cl. G06Q 30/0251

(52) U.S. Cl. CPC G06Q 30/0261; G06Q 30/0256

(57) ABSTRACT

Mechanisms are provided for automatically performing proximity based searches and reminders for items of interest. The mechanisms generate an item listing for a user having entries for things of interest (ToIs) that specify characteristics of the ToIs and notification criteria for notifying the user of availability of the ToIs within a specified proximity of a user location. Location data for locations within the proximity of the user location are processed to identify a provider that matches a characteristic of an entry of the ToI. Provider information is analyzed to determine whether the provider provides the ToI and whether conditions satisfy the notification criteria for the ToI. In response to determining that the provider provides the ToI and the conditions satisfy the notification criteria, an alert notification is output to a user computing device informing the user of the availability of the ToI within the specified proximity of the user location.

### BACKGROUND

The present application relates generally to an improved data processing apparatus and method and more specifically to an improved computing tool and improved computing tool operations/functionality for automatically performing proximity based searches and reminders for items of interest.

Location services are widely available that operate based on global positioning system (GPS) data, cellular triangulation systems, or other technologies used to identify the location of a particular computing device. Application integration allows applications, with the permission of the user, to obtain such location information about a user's device to perform their operations, such as showing digital maps of the user's surrounding location, types of establishments around the user's location, e.g., gas stations, grocery stores, etc., at a coarse grain, high level.

There are a variety of scenarios where a person may need a specific item, but has trouble actually finding that item from a location that can be reasonably accessed. For example, during certain events or holidays, e.g., Christmas, Easter, Hanukkah, Thanksgiving, Ramadan, etc., it may be difficult to find items that a user wishes to obtain for the particular holiday or event at a physical location that is readily accessible to the user, e.g., the user's usual store locations may be out of a particular toy, electronic device, or the like, at the Christmas holiday season. Similarly, it may be difficult for a user to find out of season products, accessories for older technology, or just lightly inventoried items. More recently, during the COVID-19 pandemic and subsequent supply chain issues that occurred, certain items became scarce including toilet paper, baby formula, and the like.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, computer-implemented method is provided that comprises generating an item listing data structure for a user, where the item listing data structure comprises at least one entry for at least one thing of interest (ToI) to the user, and where each entry in the at least one entry specifies characteristics of a ToI and notification criteria for notifying the user of availability of the ToI within a specified proximity of a user location associated with the user. The computer-implemented method further comprises processing location data corresponding to locations within the specified proximity of the user location to identify at least one provider of ToIs within the specified proximity that match at least one characteristic of an entry of a first ToI in the item listing data structure. The computer-implemented method also comprises collecting and analyzing provider information for the at least one provider to determine whether the at least one provider provides the first ToI and determine whether conditions associated with the at least one provider satisfy the notification criteria for the first ToI specified in the entry corresponding to the first ToI. In addition, the computer-implemented method comprises, in response to determining that the at least one provider provides the first ToI and that the conditions satisfy the notification criteria, generating an alert notification that is output to a user computing device informing the user of the availability of the first ToI within the specified proximity of the user location.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example block diagram of the primary operational elements of a proximity based search and reminder (PSR) service computing system in accordance with one illustrative embodiment;

FIG. 2 is an example diagram of a data structure for specifying items of interest in association with a user identifier in accordance with one illustrative embodiment;

FIG. 3 is an example diagram of a data structure for specifying establishment inventory of items in accordance with one illustrative embodiment;

FIGS. 4A and 4B show example diagrams of user interface output notifications specifying an item of interest is available at an establishment within proximity to the user's computing device's current location in accordance with one illustrative embodiment;

FIG. 5 is a flowchart outlining an example operation for performing a proximity based search and reminder functionality in accordance with one illustrative embodiment; and

FIG. 6 is an example diagram of a distributed data processing system environment in which aspects of the illustrative embodiments may be implemented and at least some of the computer code involved in performing the inventive methods may be executed.

### DETAILED DESCRIPTION

As noted above, there are a variety of scenarios where a person may need a specific item, but has trouble actually finding that item from a location that can be reasonably accessed. In many cases, these items are not needed at the specific moment the user looks for them, however there may not be a long time window in which to acquire them. Thus, if the user wishes to find out whether the item is in stock at reasonably accessible locations, it is left to the user to manually look for the item, either by physically visiting the locations where the user thinks the item may be present, searching inventories at the establishment's websites, if the establishment allows such functionality through their websites, or calling the establishment to speak with a representative and have them check their inventory. Then, if the item is not available at the time the user is performing the manual search, the user must repeat the attempt at a later time, and/or on a periodic basis in hopes of finding the item in stock. Currently, there is no automated computing tool that can assist users at an item level granularity in finding items present in stock at user specific accessible locations.

The illustrative embodiments provide an improved computing tool and improved computing tool functionality/operations that automatically searches for items, products, or other things of interest (ToI), based on proximity to a computing device's current location. The illustrative embodiments provide mechanisms that discover availability of ToIs within a proximity of the user's computing device, either current or at a planned future time, that may otherwise not be known to the user, i.e., the mechanisms of the illustrative embodiments synthesize known information about the environment surrounding a user's computing device within a given proximity, with known information about the ToIs and interests of the user, to reveal opportunities for the user of which the user may not otherwise be aware.

The mechanisms of the illustrative embodiments allow a user of the computing device to be notified when, for example, an item of interest is in stock at a nearby location, e.g., a particular electronic video game console is back in stock at an electronics store within the given proximity, or that a particular ToI is available within the proximity of the computing device's current location, e.g., the user may be a baseball fan, may have specified an interest in attending baseball games, and may be notified while driving through an unfamiliar area that a baseball game is currently underway within the given proximity. It should be appreciated that while the illustrative embodiments described herein will be described with reference it physical items or products of interest, the illustrative embodiments are not limited to such and may in fact be used to identify availability of other “things of interest” within a proximity of a computing device's current location, where these ToIs may include events of interest, locations of interest, availability of accommodations, or the like.

Assuming, for ease of explanation, that the ToI for which a user wishes to search is a physical item or product, the illustrative embodiments address the problems associated with manual, and repeated, user performed searches for items of interest by providing an artificial intelligence based improved computing tool that automatically, dynamically, and on a continuous or frequently periodic basis, performs searches for items at nearby establishment locations, even when the location of the computing device is moving, that match items of interest and which satisfy specified criteria. The improved computing tool implements complex artificial intelligence based evaluations of a large number of criteria, integrating data from a variety of different sources, to determine whether or not to notify a user of a computing device as to the availability of items, or ToIs, within a proximity of the current location of the computing device.

The illustrative embodiments provide such artificial intelligence based operations at an item, or ToI, level of granularity, such that different establishments or providers of a same type within a proximity of the computing device may be differentiated based on whether those establishments/providers actually have the item in stock, and whether those establishments/providers and their stocked items actually meet the requirements of the criteria specified for that item of interest, e.g., one electronics store within proximity range may not currently have the item in stock, another electronics store within proximity range may have the item in stock, but it does not satisfy other criteria specified for the item of interest, and a third electronics store within proximity range may have the item in stock and may satisfy the criteria specified for the item of interest.

With the mechanisms of the illustrative embodiments, a list of one or more ToIs, e.g., physical items/products (hereafter the ToIs will be considered items/products as a non-limiting example, and will generally be referred to as “items”), may be manually and/or automatically generated for a user of the computing device, where this computing device is preferably a portable computing device, such as a smart phone device, a tablet computing device, a laptop computing device, a vehicle mounted computing device, or other computing device that is able to be transported such that the computing device's location may change over time. As an example, an artificial intelligence (AI) computer model may monitor a user's web browser and application histories with regard to searches for items of interest and automatically determine whether to include items searched for, and/or similar items, in the item list. In some cases, the AI computer model may automatically generate a user notification suggesting that the item be added to the item list, or the similar item be added to the item list, such that the user may confirm or reject the item being added to the item list. It should be appreciated that this item in the item listing may not be for a specific instance of an item, but may be for a particular item type of interest, e.g., rather than specifying a Microsoft® Xbox® Series X with 500 GB of memory, the item may be a video game console, i.e., the items may specify interests rather than specific items. Of course, a mix of specific items and more general interests may also be utilized. For purposes of illustration, examples herein will assume that items in the listing are for specific items of interest.

In generating the item listing, search and notification criteria for each item may be set for specifying conditions under which the proximity search and reminder (PSR) computing tool of the illustrative embodiments notifies the user of the availability of the corresponding items in the item list. Each item may have a different set of search and notification criteria or the criteria may be similar for a plurality of the items in the item list. These criteria may include, for example, the item being in stock and/or a determine number of the item in stock, a condition of the item, a price or price range of the item, or other item specific criteria.

In addition, the criteria may include user specific criteria specifying conditions, other than conditions of the item itself, under which the user wishes to perform searches and be notified of item availability. For example, the user specific criteria may specify maximum purchase price of an item/product, maximum travel distance from a current location, maximum travel time from a current location, and the like. In some illustrative embodiments, the user specific criteria may include weather conditions, e.g., the user does not wish to divert to a location where the item is available when the weather is stormy, snow conditions, ice conditions, or the like. The user specific criteria may also include a distance to the location of the item, which may override a predetermined range for determining “proximity” to locations that may stock the item. The user specific criteria may also include availability of the user to obtain the item from the establishment that is within the distance or predetermined range of the computing device's current location, where availability may take into account a number of factors including distance to the establishment location, current travel speed of the computing device, current conditions along the route, e.g., accidents present, detours, other reduced flows in traffic, etc., an estimate of time required to physically obtain the item from the establishment, other events that may be present in the user's digital calendar indicating a need to be at other locations at specific times (taking into account the current time), and the like.

Essentially, the “availability” criteria, if enabled, causes the system to perform an evaluation of the various factors to determine an estimated amount of time that would be required to perform a deviation of a user's current route to the identified location of the establishment, obtain the item of interest, and return to the user's previous route, or route the user alone another route to the original destination. This estimated amount of time may be added to the current time to determine a time that the user is predicted to arrive at their original destination and compare that to the times of events in the calendar, a desired time of arrival at the original destination, or the like, and determine if the deviation to obtain the item makes the item “available” for obtaining. That is, if the estimated time of arrival (ETA) at the original destination will be later than a required ETA or scheduled time of an event, or is within a predetermined window of time of the required ETA or scheduled time of the event, then the deviation may be determined to not be available, and a notification may not be provided to the user. If the ETA is not later than the required ETA or scheduled time of an event, or if the ETA is not within the predetermined window of time, then the notification of the availability of the item at the establishment within proximity may be generated and output to the user via the computing device and a user interface presented by the computing device.

The criteria associated with an item in the item list may be specific to the particular item, such that a user may specify, via a user interface, the criteria for that particular item. In some cases, the user may establish a default set of criteria that are applied to all items unless specifically overridden by the user via the user interface. The user may establish different default criteria for different types of items, e.g., there may be different default criteria for grocery items than for electronics items. Thus, when an item is added to the item list, the default criteria for that type of item (e.g., grocery, electronics, etc.) may be retrieved and used to populate criteria for that item of interest. In a user interface for adding the item to the item list, an option may be provided to the user to override some or all of the default criteria, in which case the user's input to the interface may be used instead of the default criterion that was changed by the user's input.

The illustrative embodiments utilize a location service to identify the location of the computing device and locations of establishments nearby the computing device, i.e., within a predetermined range of the computing device's current location. The types of the establishments that are within the specified range (specified in terms of distance and/or travel time) of the computing device's current location are compared to types of establishments that stock the various items in the listing of items. That is, for each item on the item list, a watch list may be automatically generated that identifies the types of establishments that are likely to stock the item, such that each item in the list may have a different watch list. These types of establishments in each of the watch lists may be compared to the types of establishments currently within range of the current location of the computing device to perform a first level evaluation of the likelihood that an item of interest may be available at a readily accessible location. Thus, by identifying the establishments within proximity, which may be a physical distance proximity (e.g., within 10 miles) or temporal proximity (e.g., within 10 minutes of travel time), and comparing their types with the types of establishments that stock items of interest on the item listing, a subset of establishments within proximity of the current location of the computing device may be determined.

For example, the location services may provide information as to the grocery stores, electronics stores, gas stations, restaurants, convenience stores, etc., that are within a given range, or proximity, of the current location of the computing device. For purpose of the present description, the range/proximity will be considered to be a physical distance range/proximity, but similar mechanisms may be applied to temporal range/proximity criteria in a similar manner, where the locations within range of a temporal range/proximity may be determined based on an estimate of travel time to the locations based on current conditions of travel, current movement rates of the computing device, etc. For example, the location services may identify Smith's Game Store and this establishment may be determined from the database of the location services to have an establishment type of electronics store. Similarly, each specific establishment may be associated with an establishment type.

The establishment types of the establishments within the range/proximity may be compared to the establishment types that are associated with the items in the item listing. If there is a matching establishment type, then a determination may be made as to whether that particular establishment currently has the corresponding item in stock. This determination may be made by accessing inventory databases or inventory management systems of the matching establishments. In some illustrative embodiments, establishments may contract with the services of the illustrative embodiments to allow the services to access their inventory management computing systems to obtain current inventory information. This may be done on a periodic basis so as to maintain current inventory data for each contracting establishment. In some embodiments, this may involve accessing inventory data for an establishment specifically in response to a determination that the establishment matches an establishment type for an item on a user's item list.

In some illustrative embodiments, the “in stock” inventory data for the establishments within a proximity that have matching establishment types to the types associated with an item on a user's item list may be obtained by performing an automated search of an establishment's registered website, an establishment's inventory management system, or a stored current inventory database for the establishment maintained by the services provided by the illustrative embodiments, as may be compiled from periodic retrieval of inventory data from the establishments' inventory management systems. For example, if an item is a specific electronic gaming console, and it is determined that Smith's electronics is within proximity to the current location of the computing device and is of a type of establishment matching the types of establishments that provide the gaming console, then a search of inventory data for Smith's electronics may be performed to determine if that gaming console is currently in inventory at Smith's electronics. This may be accomplished by accessing inventory data for Smith's electronics via their inventory management computing system, by performing a search of Smith's electronics website inventory search portal, searching a locally stored database of Smith's electronics inventory data as may be periodically retrieved from the Smith's electronics inventory management system, or the like.

In some illustrative embodiments, providers of items, i.e., establishments, may register with the proximity based search and reminder (PSR) service computing system as a provider of items and agree to allow the PSR service computing system to access the inventory data via inventory management computing systems, or agree to report their inventory data, on a periodic basis to obtain current inventory data for the establishments, which may include multiple locations for large size establishments having multiple locations. In some cases, the establishment may allow the PSR service computing system to access a Really Simple Syndication (RSS) feed through which current inventory data may be obtained. In registering, the establishments may specify other criteria regarding their establishment and the items they offer including, but not limited to, hours of operation, items and their features such as pricing, types, product identifiers (e.g., barcodes, ISBN, or the like), RSS feed information, and the like. In embodiments where providers of items must register with the PSR service computing system, the identification of establishments within proximity to the user's location may be limited to only those establishments that have registered and thus, even if a mapping service is used as an initial basis for identify locations of establishments within a given proximity, the establishments may be filtered by those that have registered with the PSR service computing system prior to evaluating availability of items and evaluating the item of interest criteria specified in the user's item listing.

Based on whether or not the matching establishments, i.e., establishments that have a type matching a type associated with an item in the user's item list, that are within proximity to the current location of the computing device currently have the item in stock in their inventory, additional criteria may be evaluated by the AI mechanisms of the services provided by the illustrative embodiments to automatically and intelligently determine whether to notify the user of the availability of an item of interest from the user's item list, and thereby remind the user of the desire to obtain the item from a reasonably accessible location. These additional criteria may be the criteria associated with the time or interest in the user's item list, which again may be default criteria used for the various items of interest, or may be overridden criteria based on user specified criteria, e.g., rather than a default price criteria being manufacturer suggested retail price (MSRP) or less, the user may specify that MSRP+$10 or less is the user specific pricing criteria for the particular item of interest, i.e., the user is willing to pay an additional $10 to obtain the item of interest.

The additional criteria associated with the item of interest on the user's item listing may be evaluated and if each of the criteria are satisfied, then a notification may be output to the user via a user interface on their computing device indicating that an item of interest is available at a reasonably accessible location relative to the user's current location. In some illustrative embodiments, a fuzzy matching computing tool may be implemented which determines a degree of matching of the criteria, e.g., generating a matching score based on which and how many criteria are met by the conditions of the within proximity establishments and their inventory data with regard to the item of interest. This fuzzy matching may be weighted according to which criteria are determined to be of more importance to the determination of whether to present a notification of item availability. This degree of matching may be compared to one or more predetermined threshold values to determine whether to present the notification of item availability to the user via the user interface, e.g., if the degree of matching is equal to or above the predetermined value, then the notification may be presented to the user via the user interface of the computing device.

The description references the location of the user and the location of the computing device of the user. It should be appreciated that, for ease of explanation, it will be assumed that the user's location and the computing device's location are the same. This assumption is based on the computing device being a portable or vehicle mounted computing device, such that the user is transporting the computing device or is in the vehicle in which the computing device is mounted, e.g., the computing device may be a user's smart phone with location services applications, mapping services applications, and an agent application of the illustrative embodiments which interfaces with the proximity based search and reminder (PSR) service computing system, which may be offered as a cloud service or the like, of the illustrative embodiments.

Thus, having identified an establishment within the predetermined proximity of the user's current location that is provider of items of a type matching an item of interest in the user's item listing, and identified that the establishment has the item of interest in stock, and further having identified that the current conditions sufficient match the criteria associated with the item of interest in the user's item listing, a notification is output to the user via a user interface of the user's computing device to inform them of the availability of the item of interest at a reasonably accessible location relative to their current location. This notification may take many different forms depending on the desired implementation and the interfaces used to interface with other applications. For example, if an agent of the illustrative embodiments is executing on the user's computing device, and has a plug-in or other interface with a mapping service application also executing on the user's computing device, then a notification may be presented via the mapping service application that identifies, for a location shown on a displayed map, information about the available item of interest, e.g., if the map shows Smith's electronics as a location on the map, an additional notification text, image, or the like, may be associated with the location of Smith's electronics indicating the item of interest and its availability, along with any other suitable information, such as an amount of time to detour to Smith's electronics from the current location, a number of the item still in stock at Smith's electronics, pricing information for the item, a location of the item within Smith's electronics (e.g., aisle and bay information), and the like. In other illustrative embodiments, the notifications may be pop-up windows that present similar information to that described above, but which are not necessarily tied to a mapping application's display. In embodiments where the illustrative embodiments integrate with a vehicle navigation system mounted to, or implemented in the computing system of the vehicle, similar notifications may be presented on a vehicle mounted display.

The notifications via the user interfaces may be interacted with by the user via any known user interface mechanism, such as by way of user interface elements including virtual buttons, drop-down menus, check-box selection, etc., and may receive user input via any known input mechanism such as touch screens, pointing device based peripheral devices, voice input, or the like. In some illustrative embodiments, the notifications include user interface elements for permitting the user to accept or reject modifications, e.g., detours or deviations, of a current route to the location of the establishment providing an item of interest on a user's item listing. In response to the user input accepting the modification, a route to the establishment may be automatically generated and the user may be guided to the establishment via the location services and corresponding application on the user's computing device, or the like. In some illustrative embodiments, this may involve interacting with the location services to modify a previously defined route to an original destination to instead include the establishment as an intermediary waypoint along the route to the destination. Guidance may then be provided to the user, such as via the location services and/or navigation system of the computing device, to thereby guide the user to the establishment to obtain the item of interest, and thereafter continue on their route to the original destination, if one was previously defined. It should be appreciated that the illustrative embodiments do not require a predefined route be specifically define for the illustrative embodiments to operate. To the contrary, the illustrative embodiments may operate without any predefined route and instead identify establishments based only on the proximity to the current location of the user without any routes being determined or modified.

It should be appreciated that while the above description assumes a dynamic operation of the illustrative embodiments while the user's computing device is changing location, e.g., is being ported from one location to another, the illustrative embodiments are not limited to such and may in fact be performed as a preliminary operation prior to the user (and the user's computing device) initiating travel from one location to another. That is, in some illustrative embodiments, the user may define a travel route through an existing route mapping application, e.g., the Google Maps™ mapping service, a trademark of Google LLC. The projected locations along the route, e.g., each intersection of roads, at each predetermined distance along the route, or the like, may be evaluated using the mechanisms of the illustrative embodiments to determine if there are establishments within the specified proximity from the defined route that have the item of interest in stock and which meet additional criteria, if any, associated with this item of interest in the user's item listing. If so, the illustrative embodiments may notify the user and inquire as to whether the user wishes to modify the route to travel to the establishment to obtain the item of interest. If the user selects to do so, the route may be automatically updated to include the establishment as a waypoint with corresponding ETA information for arriving at the destination updated and presented to the user for approval. Assuming the user approves the modified route, the route guidance can begin.

In some illustrative embodiments, the mechanisms of the illustrative embodiments may include an online purchase functionality that operates in response to the user responding to the notification to make an online purchase of the item of interest from the establishment for in-store pickup. That is, if the establishment has the capability to perform online purchases with in-store pickup, the illustrative embodiments may present to the user, as part of the notification of the item availability, a user selectable option to perform an online in-store pickup purchase of the item. In response to the user selecting this option, the illustrative embodiments interface with the establishments' online in-store pickup purchasing system to purchase the item using a predefined payment option of the user, and designate the purchase as an in-store pickup. In this way, the user is able to purchase the item for in-store pickup while traveling so that when the user diverts to the establishment and arrives at the establishment, the item is available for pickup without having to go through the purchasing process after arrival at the establishment's location. This will speed up the process of purchasing the item of interest as well as reduce the amount of time needed for the diversion to the establishment.

In some illustrative embodiments, when the user selects the online in-store purchase option, once the purchase has been made, the item may be automatically removed from the user's item listing. In some illustrative embodiments, in addition to the other responsive user inputs that the user may make via the user interface, a user selectable option may be presented for the user to indicate to not divert their travel to the identified location and instead remove the item from the item listing, e.g., if the user determines that they no longer want to obtain the item, they may select this option to remove it from the item list and thereby not receive any future notifications with regard to that item. The agent application executing on the user's computing device may further provide item list management functionality via which the user may manually edit their item list, the criteria associated with items in the item list, and the like, so as to add/remove/modify items in the item list.

Thus, with the illustrative embodiments, automated AI based mechanisms operate based on a user's defined item list to automatically monitor the user's current location and determine establishments that have locations within a proximity of the user's current location that have an item of interest in stock and meeting the conditions established for the item of interest, e.g., pricing, number of items in stock, weather conditions for diversion of route, time to make the diversion, etc. The illustrative embodiments may automatically generate reminder notifications of such availability of items of interest at a location within a proximity of the user's current location and solicit user input specifying whether to divert, or otherwise modify a current route, so as to acquire the item from the identified location. The illustrative embodiments may further provide additional automated functionality for online in-store pickup purchasing of items, removal of items from the item list, and the like.

As an example consider a scenario in which a user, Alisha, has the latest video game console added to her item list, either having manually included it in the list or having automatically identified it from searches, web browsing, and the like, performed by Alisha on her computing device for that item or similar item and having had Alisha confirm adding it to the item list. Alisha's default criteria for items added to her item list indicates that she does not want to pay more than MSRP for any item (unless manually overridden by her) and does not want to travel more than 10 minutes out of her way, i.e., a predetermined proximity range of 10 minutes travel time from her current location or a location along a predetermined route to an original destination.

After having established the item as an item of interest in Alisha's item listing, assume that Alisha is traveling around town performing errands and needs to drop her dog off at the groomer, who is further away from her house than she normally, on a daily basis, travels such that she does not go to the location of the groomer often. As she approaches the groomer's location, based on the automatic and background operation of the mechanisms of the illustrative embodiments, the PSR service computing system determines that Smith's electronics is 7 minutes travel time away from Alisha's current location. A search of Smith's electronics inventory data, e.g., via searching periodically updated locally stored inventory data for registered establishments at the PSR service computing system, performing a search via the establishment's website, interfacing with the establishment's inventory management system, or the like, indicates that the location has the video game console in stock at the regular MSRP price. As this satisfies the notification criteria associated with the item of interest, the PSR service computing system outputs a reminder notification to Alisha about the availability of the video game console item. Alisha may then agree to divert to the establishment's location, reject the notification, select to perform an online in-store pickup of the item of interest, or have the item removed from Alisha' item list, for example. Based on Alisha's response, according responsive actions are taken to either direct Alisha to Smith's electronics, automatically perform an online in-store pickup purchase of the item, discontinue the notification but maintain the item on Alisha's item list and delaying further notifications regarding Smith's electronics for a predetermined period of time (to avoid repeated notifications that may be unwanted by the user), remove the item from Alisha's item list, and/or the like.

It should be appreciate that while the illustrative embodiments are described herein with regard to a physical item that may be purchased and obtained from a provider of the item, the illustrative embodiments are not limited to physical items. To the contrary, the item of interest may be an activity of interest, e.g., museum exhibits, movie showings, parks with certain amenities, hotels with available rooms for rent, etc. In some cases, the item may be a person of interest, e.g., a friend's current location. Other items of interest, or Things of Interest (ToIs), with which the mechanisms of the illustrative embodiments may be performed will be readily apparent to those of ordinary skill in the art in view of the present description.

That is, the illustrative embodiments operate to synthesize known information about the environment within proximity of the current location, or a planned future location, of a user's computing device, and known information about the user's ToIs, to make opportunities for acquiring or otherwise encountering the ToIs apparent to the user who otherwise may not be aware of such opportunities apart from the mechanisms of the illustrative embodiments revealing them to the user. As noted above, the ToIs are not limited to physical items/products and may include other ToIs, such as activities, experiences that the user wishes to have, people the user wishes to meet with, or the like. For example, as noted above, a user may be a baseball fan and may specify in their item listing or ToI listing that they wish to know about opportunities to go to local baseball games. If the user is driving in range of a baseball field and a baseball game is currently ongoing, or is scheduled within a given period of time of the current time, the user may be informed of the opportunity to attend the baseball game.

As another example, the user may an architecture enthusiast and may specify that the user wishes to be notified of interesting architecture that can be viewed. The mechanisms of the illustrative embodiments may determine, while the user is traveling, that there is an example of brutalist architecture that is within proximity of the user's current location or along the user's planned route and may bring the opportunity to view such architecture to the attention of the user. Similarly, the illustrative embodiments may identify a point on a historic or notable route that is within the user's interests, such as Route 66, the Appalachian Trail, a presidential library or birthplace, a museum that contains American Civil War artifacts, a national historic site, an American Revolutionary War battleground, a religious site of importance to a particular religious group, or the like. The illustrative embodiments provide mechanisms where the user can specify the types of ToIs that the user wishes to be informed of, without specifying the specific instances of these ToIs, e.g., the user may specify an interest, e.g., aerospace technology, rather than a specific museum, e.g., the Air and Space Museum in Washington, D.C. Thus, rather than having the user specify the 50 specific places the user wishes to see, the mechanisms of the illustrative embodiments may automatically identify places that satisfy the user's interests and which are within proximity of the user as the user travels in various areas that the user may not be familiar with.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

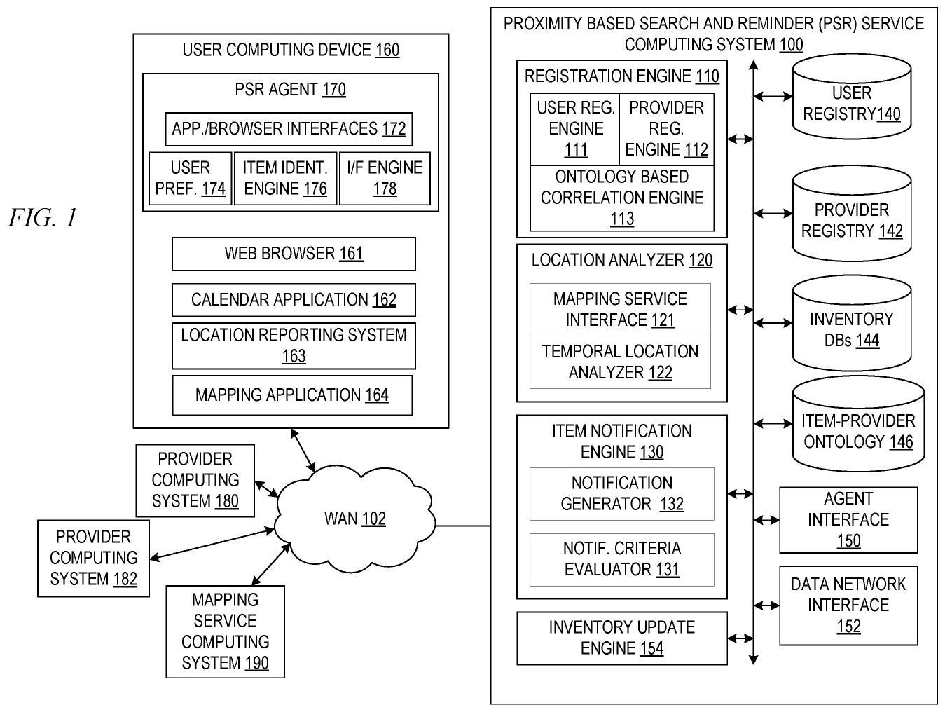

FIG. 1 is an example block diagram of the primary operational elements of a proximity based search and reminder (PSR) service computing system in accordance with one illustrative embodiment. The operational components shown in FIG. 1 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, authorization to add items of interest to a user's item listing, user preferences, etc. and the resulting output may aid human beings, e.g., notifications of item availability within a proximity of the user's current location. The invention is specifically directed to the automatically operating computer components directed to providing new computer functionality for assisting human beings in managing listings of items of interest and providing automated reminder notifications when such items are available from providers within a readily accessible proximity. The inability of human beings to perform such tasks manually is clear to those of ordinary skill in the art that have countless examples of individuals forgetting about items of interest, not being aware that such items are available at local establishments, not knowing when items come back in stock at local establishments, or the like, where “local” refers to establishments within a given proximity (temporal or physical distance) of the user's current location or planned route. These routine failures of human efforts are clear evidence that the mechanisms of the illustrative embodiments cannot be practically performed, with any guarantee of any satisfactory level of success, by human beings as a mental process or as any organization of human activity.

As shown in FIG. 1, the PSR service computing system 100 and other computing devices shown in FIG. 1 may comprise computer hardware elements, such as processors, memories, communication interfaces, operating systems, applications, libraries, data structures, and the like, that are specifically configured to implement various elements of the present illustrative embodiments as will be apparent to those of ordinary skill in the art in view of the present description. For example, the PSR service computing system 100 may comprise one or more server computing devices that are specifically configured by computer executed logic, provided in hardware and/or software, that specifically performs the functionalities attribute to the elements 110-154 shown in FIG. 1. The PSR service computing system 100 may, in some embodiments, be a cloud computing system in which the PSR service is provided as a cloud service and elements of the PSR service computing system 100 may be provided as microservices. Similarly, the user computing device 160 may comprise a portable computing device, such as a smart phone, laptop, tablet computer, vehicle mounted computing system, or the like, that is specifically configured to include a PSR agent 170 which may have the various logic and interfaces for interfacing with other applications executing on the user computing device 160, e.g., web browser 161, calendar application 162, location reporting system 163, and mapping application 164.

As shown in FIG. 1, the PSR service computing system 100 includes a registration engine 110 which comprises a user registration engine 111, a provider registration engine 112, and an ontology based correlation engine 113. These elements 111-113 comprise logic for registering users in the user registry 140, logic for registering item providers in the provider registry 142, and logic for correlating items on user item lists with providers and/or similar items using the item-provider ontology database 146 which comprises one or more data structures that identify relationships between items and providers of such items, as well as with other items of similar type. It should be appreciated that items may be associated with one or more item types (also referred to as categories or classifications), such as pizza (item) has a type of food (type, category, or classification) or video game console (item) has a type of electronics (type, category, or classification). Similarly, providers of items, e.g., establishments, have one or more corresponding provider types, such as Smith's electronics (provider) has provider types of electronics and toys (provider types, categories, or classifications). The item-provider ontology database 146 represents, in one or more data structures, relationships between specific items and specific providers and/or other similar items, and/or specific item types and specific provider types, and/or other item types of similar items. For example, the ontology may specify that a video game console has an item type of “video games” and that the item type “video games” is correlated with provider types of “electronics” and “toys”, and that the item type “video games” is a subset of a larger item type of “electronics”. Thus, the ontology 146 may map item types to provider types. In some illustrative embodiments, the item types and provider types may correspond to a standardized set of types and information fields of corresponding data structures.

The user registration engine 111 provides one or more user interfaces through which a user may register with the PSR service computing system 100 (hereafter also referred to as the PSR service 100 for simplicity) and provide authorizations for the PSR service 100 to access data about the user from one or more computing devices, e.g., the electronic calendar(s) of a calendar application 162 executing on the user's computing device 160, browsing history data of a web browser 161 of the user's computing device 160, and/or the like. In addition, the user registration engine 111 may provide one or more user interfaces through which the user may specify an initial manually generated list of items of interest, i.e., an initial item listing data structure, selecting one or more item types associated with the items of interest, and specifying one or more notification criteria for generating reminder notifications should the item be found to be in stock at an establishment of a provider within a specified proximity of the user's current location. In some illustrative embodiments, these notification criteria may include a condition of the item (e.g., used, new, “like new”, etc.), a price (e.g., MSRP, MSRP+$X, ON SALE, etc.), weather conditions (e.g., not raining, not snowing, etc.), number of units available (e.g., more than 1, 5 or more, etc.), distance (e.g., within 10 miles, within 10 minutes travel time, etc.), availability (e.g., can reach original destination within X minutes of original time, delay less than a predetermined amount of time, etc.). In some illustrative embodiments, the user may specify a default set of notification criteria that may be used as a default for each item of interest added to the user's item listing data structure, unless the user specifically overrides the default settings of these notification criteria.

In response to the user registering with the PSR service 100 via the user registration engine 111, and in response to the user providing authorizations, the user registration engine 111 may install on the user's computing device 160, a PSR agent application 170 that executes on the user's computing device 160. The PSR agent 170 operates to monitor and gather data from applications 161-164 executing on the user's computing device 160 that is relevant to item identification and item availability determinations. The PSR agent 170 comprises the application/browser interfaces 172, user preferences data structure 174, item identification engine 176, and interface (I/F) engine 178. The application/browser interfaces 172 may comprise Application Programming Interfaces (APIs), plug-ins, or any other data gathering and command interfaces through which the PSR agent 170 may gather data and/or issue commands and inputs to the applications/web browser executing on the user computing device 160. The user preferences data structure 174 may be configured by user inputs to the PSR agent 170 to specify various preferences of the user for the performance of operations by the PSR agent 170, e.g., whether to automatically add items of interest to an item list if the items of interest where added to a shopping cart, generating a notification if the item of interest was part of a search query but not added to a shopping cart, never automatically add an item of interest and instead always ask the user, display settings for interfaces, what applications/browsers to monitor, etc. The item identification engine 176 provides the logic for determining whether to add items to a user's item listing data structure at the PSR service 100. The interface engine 178 comprises logic for generating user interfaces and reminder notifications, as well as in some cases supplementing interfaces of other applications, e.g., the mapping application 164, with additional interface elements, e.g., pop-up notifications or the like.

As shown in FIG. 1, the PSR agent 170 may include an application/browser interface 172 that monitors applications and web browsers to identify searches that the user performs for items of interest. For example, in some cases, item providers may have their own applications through which a user may search for items and/or select items of interest for addition to virtual shopping carts or the like, and these searches/selections may be monitored. The item identification engine 176 comprises logic for evaluating whether items referenced in searches or selections meet criteria for inclusion in an item listing data structure for the user. A rules based engine or AI computer model trained on data representing patterns of user inputs, e.g., selections and/or search criteria, may be used to determine whether an item should be included in an item listing data structure. In some illustrative embodiments, the item identification engine 176 may send requests to the PSR service 100 to provide recommendations of similar items that may be of interest to the user based on the items of interest identified by the item identification engine 176. In response, the PSR service 100 may search the ontology data structure 146 for similar items of similar item types and provide those recommendations based to the item identification engine 176 for presentation to the user via the interfaces of the interface engine 178 for user specification of which items, if any, to add to the user's item listing.

Based on user preferences 174, and a determination that an item should be included in the item listing data structure, actions may be initiated by the item identification engine 176 in accordance with the user preferences 174. For example, if the determination is that the item should be included, then a user notification may be output via the interface engine 178 requesting the user acknowledge that the item should be added or declining the addition of the item to the user's item listing. If the user input is to add the item, a corresponding communication to the PSR service 100 may be generated to add the item to the user's item listing in the user registry 140 via the agent interface 150 and data network interface 152.

The web browser 161 provides a mechanism through which a user may search for content and, with regard to items of interest, may search generally or on specific websites, forums, social media, or the like, for specific items of interest and/or engage in purchasing of items of interest. The calendar application 162 provides an electronic calendar in which events, meetings, and the like, may be scheduled and tracked. The location reporting system 163 may comprise any location identification system, such as a global positioning system (GPS), cellular triangulation system, or the like, to identify the user's current location and report that current location to the PSR service 100. The mapping application 164 may interface with the location reporting system 163 and the PSR agent 170 to present to the user a graphical representation of the user's current location and other establishments and points of interest near the user's current location, provides a user interface through which the user may interact with such a graphical representation, and which can be used to identify locations of establishments within a given proximity of the user's current location. In some cases, the mapping application 164 may be used to map a route from a user's current location, or a specified starting location, to a destination location, and in accordance with the illustrative embodiments, identify establishments and points of interest within a specified proximity of points along the predefined route. The mapping application 164 may interface with a mapping service computing system 190 via the data network 102 to obtain the data for generating such representations and identifying nearby establishments and points of interest. The mapping application 164 may interface with the PSR agent 170 to obtain the proximity parameters and report back to the PSR agent the establishments and points of interest within the specified proximity.

With reference again to the elements of the PSR service 100, the provider registration engine 112 provides one or more user interfaces through which a representative of an item provider may register with the PSR service 100 and provide authorizations for the PSR service 100 to access inventory data from one or more computing systems associated with the item provider. For example, the registration may specify information including items and/or item types that the provider provides, hours of service, APIs for accessing inventory data, Really Simple Syndication (RSS) feed information for providing inventory data to the PSR service 100, security and access information for accessing inventory management systems of one or more provider computing systems 180-182, and the like. In addition, the provider registration engine 112 may provide one or more current inventory data structures that specify the current inventory of the provider's establishments as an initial set of one or more inventory databases 144, e.g., there may be a separate inventory database for each establishment of each provider so that the availability of items on a per-establishment basis may be determined.

The location analyzer 120 of the PSR service 100 comprises a mapping service interface 121 and temporal location analyzer 122. It should be appreciated that while the location analyzer 120 is shown as being part of the PSR service 100 apart from the user computing device 160, this is only one possible embodiment. In other embodiments, the location analyzer 120, as well as the item notification engine 130 and other elements of the PSR service 100, e.g., user registry 140, may be part of the PSR agent 170 executing on the user's computing device 160 such that the functionality of these elements is executed at the user computing device 160.

The location analyzer 120 comprises logic that operates to determine the identified establishments within proximity to the user's current location, as reported by the location reporting system 163 and identified via the mapping service interface 120 that communicates with the mapping service computing system 190 via the data network interface 152 and the data network(s) 102, that have a provider type that matches an item type of an item in the user's item listing as stored in the user registry 140. The location analyzer 120 may identify which, if any, of the establishments within proximity of the current user's location have a provider type that matches the item types of one or more items on the user's item list, potentially using the item-provider ontology 146 to correlate item types with provider types. For those establishments that are within proximity and have a matching type to an item type of an item on the user's item listing in the user registry 140, the location analyzer 120 may further search the inventory database(s) 144 corresponding to the establishment to determine if the establishment has the item of interest in stock or not. For those establishments within proximity, having a matching provider type, and that have the item in stock, additional evaluations of temporal conditions and/or notification criteria may be performed by the temporal location analyzer 122 and the item notification engine 130.

The temporal location analyzer 122 identifies those establishments that are within a temporal proximity of the user's current location, e.g., evaluating travel time to the establishment locations, evaluating estimated times to complete transactions at the establishment locations, and the like, to determine if temporal based notification criteria for items are satisfied should a detour to the location of the establishment be performed. These establishments may be a subset of the establishments identified by the location analyzer 120 based on physical proximity or may be a separately determined set of establishments. The temporal location analyzer 122 evaluates these establishments with regard to time and amounts of time that detours to the establishments would cause in a user's planned travel route or as a general amount of time to complete the travel to the establishment and complete a transaction to obtain the item of interest from the user's item listing. This may involve evaluations of not only travel time based on predicted travel route conditions, weather conditions, current travel speed of the user, etc., but also time to complete a transaction, which may be different based on whether the user performs an online in-store pickup purchase of the item, a time of year, e.g., holiday seasons may have larger crowds as establishments and may cause additional delays, and the like. The predicted temporal factors may be combined with calendar application 162 data indicating scheduled events and their times of day, original time of arrival at an original destination, and the like, to determine if the detour to the establishment meets with the temporal notification criteria associated with the item of interest in the user's item listing in the user register 140.

The item notification engine 130 comprises the logic for determining whether to issue an item availability reminder notification to the user computing device 170 via the PSR agent 170 and the agent interface 150, and further comprises logic for generating the item availability reminder notification for presentation by the PSR agent 170 to the user via one or more user interfaces and the interface engine 178. The item notification engine 130 comprises the notification criteria evaluation engine 131 which operates to evaluate each of the notification criteria associated with the item of interest in the item listing for the user. The notification criteria evaluation engine 131 may use a fuzzy matching operation to determine a degree of matching of the notification criteria and evaluate whether that degree of matching meets or exceeds a predetermined threshold level of matching to warrant issuing a notification of item availability to the user. The notification generator 132 comprises the logic for generating the content of item availability notification for providing to the PSR agent 170 for presentation to the user via the interface engine 178.

The inventory update engine 154 comprises logic for maintaining the inventory databases 144 for the providers, and provider establishments, up-to-date. The inventory update engine 154 may monitor RSS feeds for the various providers, send requests for inventory data to the inventory management systems of the provider computing systems 180-182, or the like, to obtain current inventory data for the providers and provider establishments. The inventory update engine 154 updates the corresponding inventory databases 144 based on the received inventory data.

Thus, the illustrative embodiments provide improved computer functionality and improved computing tools that implement artificial intelligence based operations at an item level of granularity, such that different establishments of a same type within a proximity of the computing device may be differentiated based on whether those establishments actually have the item in stock, and whether those establishments and their stocked items actually meet the requirements of the criteria specified for that item of interest, e.g., one electronics store within proximity range may not currently have the item in stock, another electronics store within proximity range may have the item in stock, but it does not satisfy other criteria specified for the item of interest, and a third electronics store within proximity range may have the item in stock and may satisfy the criteria specified for the item of interest. The illustrative embodiments operate automatically once configured such that a user does not need to remember to look for items of interest at potential providers of those items, does not have to identify which providers are likely to provide those items of interest, does not have to manually perform searches of inventory of those providers to determine if they currently have the items in stock under conditions satisfactory to the user, and does not have to manually perform such searches dynamically as the user's location changes over time, especially in cases where providers of items in locations seldom traveled by the user are not known to the user.

With the mechanisms of the illustrative embodiments, a list of one or more physical items/products (hereafter generally referred to as “items”) may be manually and/or automatically generated for a user of the computing device 160, stored in the user registry 140, and automatically managed over time. As an example, an artificial intelligence (AI) computer model may monitor a user's web browser 161 and application histories with regard to searches for items of interest and automatically determine whether to include items searched for, and/or similar items, in the item list maintained in the user registry 140 in association with an identifier of the user. In some cases, the AI computer model of the item identification engine 176 may automatically generate a user notification, via the interface engine 178, suggesting that the item be added to the item list, or the similar item be added to the item list, such that the user may confirm or reject the item being added to the item list.

In generating the item listing, search and notification criteria for each item may be set for specifying conditions under which the PSR service 100 notifies the user of the availability of the corresponding items in the item list. Each item may have a different set of search and notification criteria, also referred to herein generally as “notification criteria,” or the criteria may be similar for a plurality of the items in the item list. These criteria may include, for example, the item being in stock and/or a determine number of the item in stock, a condition of the item, a price or price range of the item, or other item specific criteria.

In addition, the criteria may include user specific criteria specifying conditions, other than conditions of the item itself, under which the user wishes to perform searches and be notified of item availability. For example, these user specific criteria may include weather conditions, e.g., the user does not wish to divert to a location where the item is available when the weather is stormy, snow conditions, ice conditions, or the like. The user specific criteria may also include a distance to the location of the item, which may override a predetermined range for determining “proximity” to locations that may stock the item. These various criteria may be evaluated by the item notification engine 130 to determine whether to send an item availability notification to the user via the PSR agent 170.

The user specific criteria may also include availability of the user to obtain the item from the establishment that is within the distance or predetermined range of the computing device's current location, where availability may take into account a number of factors including distance to the establishment location, current travel speed of the computing device, current conditions along the route, e.g., accidents present, detours, other reduced flows in traffic, etc., an estimate of time required to physically obtain the item from the establishment, other events that may be present in the user's digital calendar indicating a need to be at other locations at specific times (taking into account the current time), and the like.

Essentially, the “availability” criteria, if enabled, causes the temporal analyzer 122 to perform an evaluation of the various factors to determine an estimated amount of time that would be required to perform a deviation of a user's current route to the identified location of the establishment, obtain the item of interest, and return to the user's previous route, or route the user alone another route to the original destination. This estimated amount of time may be added to the current time to determine a time that the user is predicted to arrive at their original destination and compare that to the times of events in the calendar, a desired time of arrival at the original destination, or the like, and determine if the deviation to obtain the item makes the item “available” for obtaining. That is, if the estimated time of arrival (ETA) at the original destination will be later than a required ETA or scheduled time of an event, or is within a predetermined window of time of the required ETA or scheduled time of the event, then the deviation may be determined to not be available, and a notification may not be provided to the user. If the ETA is not later than the required ETA or scheduled time of an event, or if the ETA is not within the predetermined window of time, then the notification of the availability of the item at the establishment within proximity may be generated by the item notification engine 130 and output to the user via the PSR agent 170 on the user computing device 160 and a user interface presented by the PSR agent 170 via the interface engine 178 using the notification generated by the notification generator 132.

The criteria associated with an item in the item list of the user registry 140 may be specific to the particular item, such that a user may specify, via a user interface of the user registration engine 111, the criteria for that particular item. In some cases, the user may establish a default set of criteria that are applied to all items unless specifically overridden by the user via the user interface. The user may establish different default criteria for different types of items, e.g., there may be different default criteria for grocery items than for electronics items, and these different default criteria may be stored as different profiles in the user registry 140. All data in the user registry 140 for a particular user may be tied to a user identifier for the user. Thus, when an item is added to the item list, the default criteria for that type of item (e.g., grocery, electronics, etc.) may be retrieved and used to populate criteria for that item of interest. In a user interface of the user registration engine 111, for adding the item to the item list, an option may be provided to the user to override some or all of the default criteria, in which case the user's input to the interface may be used instead of the default criterion that was changed by the user's input.

The illustrative embodiments utilize a location service, such as may be accessed via the location reporting system 163 and mapping application 164, to identify the location of the computing device 160 and locations of establishments nearby the computing device 160, i.e., within a predetermined range of the computing device's current location. The types of the establishments that are within the specified range (specified in terms of distance and/or travel time) of the computing device's current location are compared to types of establishments that stock the various items in the listing of items, e.g., using the item-provider ontology 1465 and the lotic of the location analyzer 120. That is, for each item on the item list, a watch list may be automatically generated that identifies the types of establishments that are likely to stock the item, such that each item in the list may have a different watch list stored as part of the user registry 140 and the item listing data structure of the user registry 140 for the particular user. These types of establishments in each of the watch lists may be compared to the types of establishments currently within range of the current location of the computing device to perform a first level evaluation of the likelihood that an item of interest may be available at a readily accessible location. Thus, by identifying the establishments within proximity, via the mapping service computing system 180 and mapping service interface 121, and the current location of the computing device 160 as indicated by the location reporting system 163, and comparing their types with the types of establishments that stock items of interest on the item listing, a subset of establishments within proximity of the current location of the computing device may be determined.

The establishment types of the establishments within the range/proximity may be compared, by the location analyzer 120, to the establishment types that are associated with the items in the item listing. If there is a matching establishment type, then a determination may be made as to whether that particular establishment currently has the corresponding item in stock. This determination may be made by accessing inventory databases 144 which are kept up-to-date by the inventory update engine 154. In some illustrative embodiments, the “in stock” inventory data for the establishments within a proximity that have matching establishment types to the types associated with an item on a user's item list may be obtained by performing an automated search of an establishment's registered website, an establishment's inventory management system, or a stored current inventory database for the establishment maintained by the services provided by the illustrative embodiments, as may be compiled from periodic retrieval of inventory data from the establishments' inventory management systems. In some illustrative embodiments, providers of items, i.e., establishments, may register with the PSR service 100, via the provider registration engine 112, as a provider of items and agreeing to allow the PSR service 100 to access the inventory data via inventory management computing systems 180-182, or agreeing to report their inventory data on a periodic basis, such as via RSS feeds or push notifications, such that the inventory update engine 154 obtains current inventory data for the establishments, which may include multiple locations for large size establishments having multiple locations.

Based on whether or not the matching establishments, i.e., establishments that have a type matching a type associated with an item in the user's item list, that are within proximity to the current location of the computing device currently have the item in stock in their inventory, additional criteria may be evaluated by the item notification engine 130 to automatically and intelligently determine whether to notify the user of the availability of an item of interest from the user's item list, and thereby remind the user of the desire to obtain the item from a reasonably accessible location. It should be appreciated that these criteria allow the PSR service 100 to distinguish between cases where the item is in stock and a notification is sent, and cases where the item is in stock, but a notification is not sent. That is, notification is not only dependent upon the item being in stock or not. These additional criteria may be the criteria associated with the time or interest in the user's item list, which again may be default criteria used for the various items of interest, or may be overridden criteria based on user specified criteria, e.g., rather than a default price criteria being manufacturer suggested retail price (MSRP) or less, the user may specify that MSRP+$10 or less is the user specific pricing criteria for the particular item of interest, i.e., the user is willing to pay an additional $10 to obtain the item of interest.

The additional criteria associated with the item of interest on the user's item listing in the user registry 140 may be evaluated and if each of the criteria are satisfied, then a notification may be output to the user via the item notification engine 130 and PSR agent 170 as a user interface generated by the interface engine 178 on the user computing device 160 indicating that an item of interest is available at a reasonably accessible location relative to the user's current location. As noted above, in some illustrative embodiments, the item notification engine 130 may implement a fuzzy matching functionality which determines a degree of matching of the criteria, e.g., generating a matching score based on which and how many criteria are met by the conditions of the within proximity establishments and their inventory data with regard to the item of interest. This fuzzy matching may be weighted according to which criteria are determined to be of more importance to the determination of whether to present a notification of item availability. This degree of matching may be compared to one or more predetermined threshold values to determine whether to present the notification of item availability to the user via the user interface, e.g., if the degree of matching is equal to or above the predetermined value, then the notification may be presented to the user via the user interface generated by the interface engine 178 based on the generated notification from the notification generator 132 of the item notification engine 130.

Having identified an establishment within the predetermined proximity of the user's current location that is provider of items of a type matching an item of interest in the user's item listing (using the location services of mapping service computing system 190, current location as reported by the location reporting system 163, the provider registry 142, and item-provider ontology 146), and identified that the establishment has the item of interest in stock (e.g., using the location analyzer 120 and inventory databases 144 maintained by the inventory update engine 154 for registered providers in the provider registry 142 and their establishments), and further having identified that the current conditions sufficiently match the criteria associated with the item of interest in the user's item listing (e.g., using notification criteria evaluator 131 and the criteria set forth in the user registry 140), a notification generated by the notification generator 132 is output to the user via the agent interface 150 and the interface engine 178 of the PSR agent 170, to inform them of the availability of the item of interest at a reasonably accessible location relative to their current location.

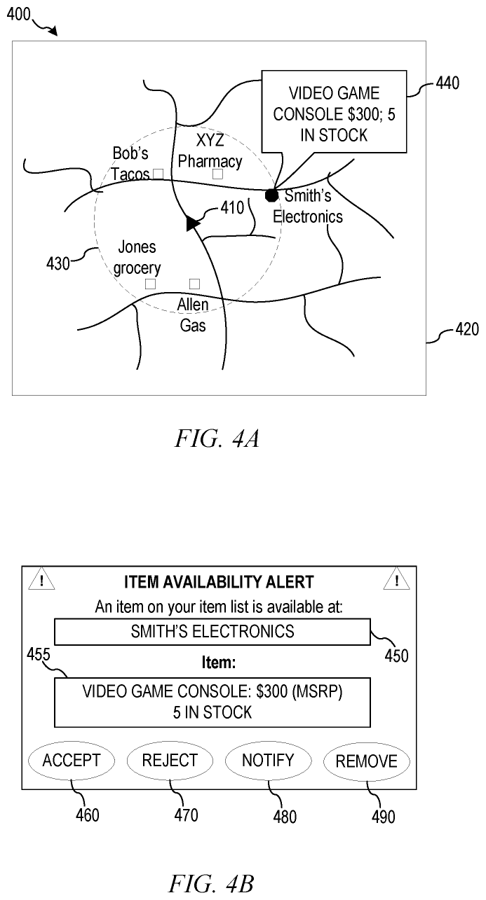

This notification may take many different forms depending on the desired implementation and the interfaces used to interface with other applications. Examples of such notifications and interfaces will be discussed hereafter with regard to FIGS. 4A and 4B. For example, if the PSR agent 170 of the illustrative embodiments is executing on the user's computing device 160, and has a plug-in or other interface with a mapping service application 164 also executing on the user's computing device 160, then a notification may be presented via the mapping service application that identifies, for a location shown on a displayed map, information about the available item of interest, e.g., see FIG. 4A. In other illustrative embodiments, the notifications may be pop-up windows which are not necessarily tied to a mapping application's display, e.g., see FIG. 4B. In embodiments where the illustrative embodiments integrate with a vehicle navigation system mounted to, or implemented in the computing system of the vehicle, similar notifications may be presented on a vehicle mounted display.

The notifications via the user interfaces may be interacted with by the user via any known user interface mechanism, such as by way of user interface elements including virtual buttons, drop-down menus, check-box selection, etc., and may receive user input via any known input mechanism such as touch screens, pointing device based peripheral devices, voice input, or the like. In some illustrative embodiments, the notifications include user interface elements for permitting the user to accept or reject modifications, e.g., detours or deviations, of a current route to the location of the establishment providing an item of interest on a user's item listing. In response to the user input accepting the modification, a route to the establishment may be automatically generated and the user may be guided to the establishment via the location services and corresponding application on the user's computing device, or the like. That is, in some illustrative embodiments, the PSR agent 170 may interact with the location services of the mapping application 164 and location reporting system 163 to modify a previously defined route in the mapping application 164 to an original destination, to instead include the establishment as an intermediary waypoint along the route to the destination. Guidance may then be provided to the user, such as via the location services and/or navigation system of the computing device provided by the mapping application 164, to thereby guide the user to the establishment to obtain the item of interest, and thereafter continue on their route to the original destination, if one was previously defined. If no previously defined route is present, then a route to the location of the establishment may simply be generated and guidance to the location provided.

As noted previously, the mechanisms of the illustrative embodiments may operate dynamically as the user's location is changing, and/or may be implemented in an a priori manner, i.e., before travel starts, so as to evaluate a route prior to the user progressing along the route. In some cases, the illustrative embodiments may be operated as a predictive mechanism such that as the user is progressing along a predefined route, points along the route ahead of the user's current location may be analyzed and evaluated as discussed above to determine if there are any potential detours to establishments within proximity that have items of interest on the user's item listing data structure that meet the notification criteria. That is, in some illustrative embodiments, the user may define a travel route through an existing route mapping application, e.g., the Google Maps™ mapping service, a trademark of Google LLC. The projected locations along the route, e.g., each intersection of roads, at each predetermined distance along the route, or the like, may be evaluated using the mechanisms of the illustrative embodiments to determine if there are establishments within the specified proximity from the defined route that have the item of interest in stock and which meet additional criteria, if any, associated with this item of interest in the user's item listing. If so, the illustrative embodiments may notify the user and inquire as to whether the user wishes to modify the route to travel to the establishment to obtain the item of interest. If the user selects to do so, the route may be automatically updated to include the establishment as a waypoint with corresponding ETA information for arriving at the destination updated and presented to the user for approval. Assuming the user approves the modified route, the route guidance can begin. This may be done prior to traveling along the route, or for points along the route ahead of the user's current location on the route.

In some illustrative embodiments, the mechanisms of the illustrative embodiments may include an online purchase functionality that may be implemented in the PSR agent 170, which operates in response to the user responding to the notification presented via the interface engine 178. That is, the PSR agent 170 may interface with purchasing systems of registered providers 142 so as to make online purchase of items and designate that those items are to be picked up in-store with the user being in-route to the location. The user may be presented with this option through a user interface element of the notification output to the via the interface engine 178. Thus, when the user selects this option via the interface, the PSR agent operates to make an online purchase of the item of interest from the establishment for in-store pickup. A predefined payment option of the user may be used to purchase the item, e.g., an electronic wallet, a credit card on file, or the like. In this way, the user is able to purchase the item for in-store pickup while traveling so that when the user diverts to the establishment and arrives at the establishment, the item is available for pickup without having to go through the purchasing process after arrival at the establishment's location. This will speed up the process of purchasing the item of interest as well as reduce the amount of time needed for the diversion to the establishment.

The user's item listing data structure may be automatically updated by the registration engine 110 in response to user inputs via the interface engine 178 of the PSR agent 170. For example, in some illustrative embodiments, when the user selects the online in-store purchase option, once the purchase has been made, the item may be automatically removed from the user's item listing in the user's entry of the user registry 140. In some illustrative embodiments, in addition to the other responsive user inputs that the user may make via the user interface, a user selectable option may be presented for the user to indicate to not divert their travel to the identified location and instead remove the item from the item listing in which case the user registry 140 is updated to remove the item from the item listing, e.g., if the user determines that they no longer want to obtain the item, they may select this option to remove it from the item list and thereby not receive any future notifications with regard to that item. The PSR agent 170 executing on the user's computing device 160 may further provide item list management functionality via which the user may manually edit their item list, the criteria associated with items in the item list, and the like, so as to add/remove/modify items in the item list.

Thus, with the illustrative embodiments, automated computer AI based mechanisms operate based on a user's defined item list to automatically monitor the user's current location and determine establishments that have locations within a proximity of the user's current location that have an item of interest in stock and meeting the conditions established for the item of interest, e.g., pricing, number of items in stock, weather conditions for diversion of route, time to make the diversion, etc. The illustrative embodiments may automatically generate reminder notifications of such availability of items of interest at a location within a proximity of the user's current location and solicit user input specifying whether to divert, or otherwise modify a current route, so as to acquire the item from the identified location. The illustrative embodiments may further provide additional automated functionality for online in-store pickup purchasing of items, removal of items from the item list, and the like.

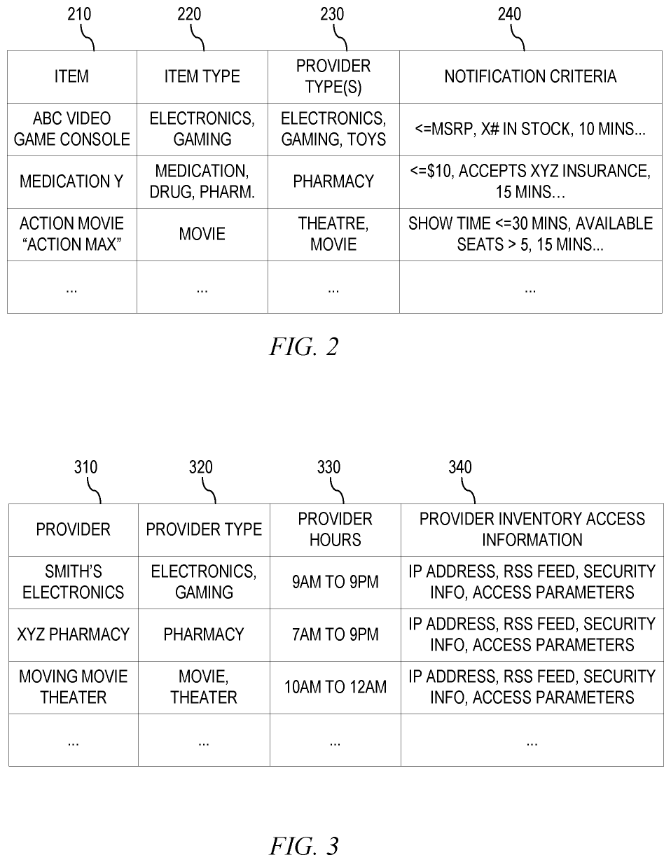

As noted above, the illustrative embodiments operate based on manually and/or automatically generated item listing data structures that specify items of interest and their corresponding item/provider types and their notification criteria. FIG. 2 is an example diagram of a data structure for specifying items of interest in association with a user identifier in accordance with one illustrative embodiment. As shown in FIG. 2, the item listing data structure comprises an item identifier 210, an item type 220, a provider type 230, and notification criteria 240. The item identifier 210 specifies a particular item identifier that identifies the specific item, rather than a more general item type. For example, the item identifier may be a specific video game console, e.g., the ABC video game console for general purposes in this example, but in concrete terms may be for example a PlayStation 5 gaming console, an Xbox Series X gaming console, or the like. The item type is a classification, category, or type of the item specified in the item identifier 210 and is used to map to provider types via an ontology data structure so as to identify similar items and/or providers that provide that type of item. For example, an item type may be electronics, gaming, medication, drug, pharmaceutical (pharm), movie, toy, etc.

The provider type 230 specifies the types of providers that provide the item identified by the item identifier 210 having the item type(s) specified in the item type 220. For example, providers having the type “electronics”, “gaming”, and/or “toys” may provide the ABC video game console as indicated by the ontology having relationships between item types of “electronics” and “gaming”, and provider types of “electronics”, “gaming”, and “toys”. Thus, item types may be correlated with provider types, and provider types may be used to match with providers found to be within a proximity of the user's current location or a projected location along a predefined route.

The notification criteria 240 specify item conditions and/or user conditions under which notification, that an item is available at a reasonably accessible location within proximity to the user's current or projected location, may be made. This criteria may include item criteria such as condition, price, number in stock, etc. and user specified conditions such as weather, travel time, delay time, distance, etc. These criteria may be specified as positive (e.g., equal to or less than MSRP) or negative criteria (e.g., not greater than MSRP, not raining, etc.).

As shown in FIG. 2, while the illustrative embodiments are primarily described with reference to purchasable items that can be physically acquired by the user, the illustrative embodiments are not limited to such. For example, in FIG. 2, the items include a movie “Action Max” that the user may go to see. Thus, the “items” may be physically acquirable items, but may also include events that may be experienced, people that may be visited, and other experience based items.

The illustrative embodiments further operate on provider registry data that identifies the various aspects of the providers of items such that providers within a proximity that provide items of a type corresponding to items on a user's item list may be identified. FIG. 3 is an example diagram of a data structure for specifying establishment inventory of items in accordance with one illustrative embodiment. As shown in FIG. 3, the provider registry data may include, among other data, a provider identifier 310, a provider type 320, provider hours of operation 330, and provider inventory access information 340. The provider identifier 310 is a unique identifier of a provider and/or provider establishment, which can be used to correlate with the establishments identified by the location and mapping services to identify providers that are within a given proximity (temporal and or physical distance proximity) of the user's current location or a projected location along a predefined route. The provider type 320 may be used to identify the type of provider and correlate this type with item times via an ontology data structure as discussed above. The provider hours of operation 330 may be utilized by the temporal location analyzer 122 of the location analyzer 120 to evaluate when and whether the user can travel to a location of a provider to obtain an item of interest, e.g., if the establishment is not yet open, or is going to close before the user can travel to the location, then the temporal location analyzer may determine to not send a notification to the user. The provider inventor access information provides the necessary information for accessing up-to-date inventory information from the provider computing systems, e.g., RSS feed information, IP addresses of provider computer systems, security information for accessing inventory management systems, and the like.

FIGS. 4A and 4B are example diagrams of user interfaces and item availability notifications specifying an item of interest is available at an establishment within proximity to the user's computing device's current location in accordance with one illustrative embodiment. FIG. 4A shows a first user interface in which a graphical interface of a local map generated by a mapping application 164 is output and is augmented by the mechanisms of the illustrative embodiments, e.g., the PSR agent 170 operating in conjunction with the PSR service 100, to graphically represent a proximity and an item availability notification. FIG. 4B is an example of another user interface that may be generated that is not tied to the graphical representation generated by a mapping application, or which can be presented in response to a user selecting the notification shown in FIG. 4A. It should be appreciated that these interfaces are only examples and are not intended to state or imply any limitation with regard to the present invention.

For example, as shown in FIG. 4A the interface 400 includes a representation of the user's current location 410 on a graphical map 420 of the local region, along with various establishments around the user's current location. The interface 400 further includes a graphical representation of a proximity 430 which corresponds to one or more items of interest on the user's item list. As can be seen from the depiction in FIG. 4A, Smith's electronics is located within this proximity 430 and, through the mechanisms of the illustrative embodiments, is determined to have a video game console in stock and meeting the notification criteria of the item in the user's item listing data structure. Thus, a notification 440 is output and overlayed on the graphical map 420 with specific identification of the notification 440 being associated with the Smith's electronics location, e.g., by way of the pointer to the graphical icon representing Smith's electronics. The notification 440 may specify various parameters of the offering from Smith's electronics, as may be obtained from the inventory database entries for Smith's electronics, e.g., item identifier, price, number in stock, etc.

FIG. 4B shows another type of item availability notification in which user selectable interface elements are provided. In this notification, which may be provided in response to the user interacting with the notification 440 in FIG. 4A, or as a separate notification not tied to the map output shown in FIG. 4A, the notification identifies the location 450 where the item is determined to be available and meeting the conditions for notification specified in the item listing data structure, and details of the item and the establishments' offering of the item 455. In addition, user selectable buttons 460-490 are provided to allow the user to indicate how the user wishes to proceed based on the item availability notification. For example, if the user wishes to accept the deviation of the user's current travel so that the user will go to the identified location to pick up the item of interest, then the user may select the Accept virtual button 460. If the user wishes to reject the notification and not deviate, then the user may select the Reject virtual button 470. If the user wishes to instead remove the item from the user's item listing, then the user may select the Remove virtual button 490.

If the user wishes to ignore the notification but keep the item on the item list for later notifications, then the user may select the Notify Later virtual button 480. It should be appreciated that in some illustrative embodiments, in response to the user selecting the Notify Later virtual button 480, notifications regarding the specific provider and/or item on the item list may be turned off for a predetermined window of time after the user's input, e.g., no more notifications regarding that item for 1 hour. This time delay may be user specified, such as via the user preferences 174 in FIG. 1. Thus, while the PSR service 100 may send a notification to the PSR agent 100, if the notification includes the item of interest or the provider, the notification may be inhibited by the PSR agent 170 from being presented to the user. It should be appreciated that the notifications via the user interfaces may be interacted with by the user via any known user interface mechanism, such as by way of user interface elements including virtual buttons, drop-down menus, check-box selection, etc., and may receive user input via any known input mechanism such as touch screens, pointing device based peripheral devices, voice input, or the like.

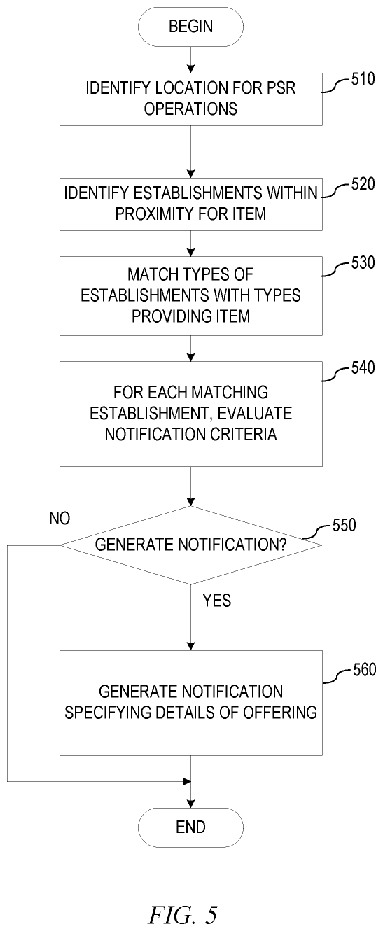

FIG. 5 is a flowchart outlining an example operation for performing a proximity based search and reminder functionality in accordance with one illustrative embodiment. It should be appreciated that the operations outlined in FIG. 5 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 5, and may, in some cases, make use of the results generated as a consequence of the operations set forth in FIG. 5, the operations in FIG. 5 themselves are specifically performed by the improved computing tool in an automated manner.

The operation outlined in FIG. 5 assumes that a user has already registered with the PSR service 100 and has either provided or had automatically generated, an item listing data structure for items of interest to the user. For purposes of the description of FIG. 5, the operation is described with reference to a single item on a user's item listing data structure, but it should be appreciated that the operation is repeated for each item on the user's item listing data structure and at each determined location over time. In addition, the operation assumes that providers have already registered with the PSR service 100 and inventory data for these providers has been compiled. Moreover, an item-provider ontology data structure is also assumed to be present, as described herein above.

As shown in FIG. 5 the operation starts by identifying a location for which proximity based search and reminder operations are to be performed (step 510). This location may be the user's current location or a projected location along a predetermined route, for example. The establishments within a specified proximity, of the identified location, for the item of interest are identified (step 520). This proximity may be a physical distance, a temporal proximity based on travel time, purchase time, etc., or a combination of physical distance and temporal proximity.

The types of the establishments are matched to the types of establishments providing the item of interest as specified in the item listing data structure (step 530). For each matching establishment, i.e., an establishment having a type matching one of the types associated with the item of interest, additional notification criteria are evaluated (step 540). The evaluation of the notification criteria specifies whether or not a notification should be output to the user indicating that an item of interest on their item listing data structure is available from an establishment within the specified proximity (step 550). If a notification is to be generated, then the notification is generated and sent to the user's computing device for presentation to the user (step 560). If the notification is not to be generated, as determined from the evaluation of the notification criteria, then the notification is not generated and the operation terminates.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides a proximity based search and reminder service computing tool and improved proximity based search and reminder service computing tool functionality. The improved computing tool implements mechanism and functionality, such as the PSR service computing system and its corresponding functionality which operate automatically once configured with a user's item list and only require the user to provide inputs when notified of item availability to know whether the user wishes to divert to a location within proximity. This automatic functionality of the illustrative embodiments cannot be practically performed by human beings either outside of, or with the assistance of, a technical environment, such as a mental process or the like. The improved computing tool provides a practical application of the methodology at least in that the improved computing tool is able to identify locations within a given proximity of a user's current location, dynamically as that location is changing, that provide items of the type corresponding to items in the user's item listing, and which satisfy the various criteria associated with the items in the user's item listing, and which actually have the items in the item listing in stock so that the user may be able to acquire the items of interest.

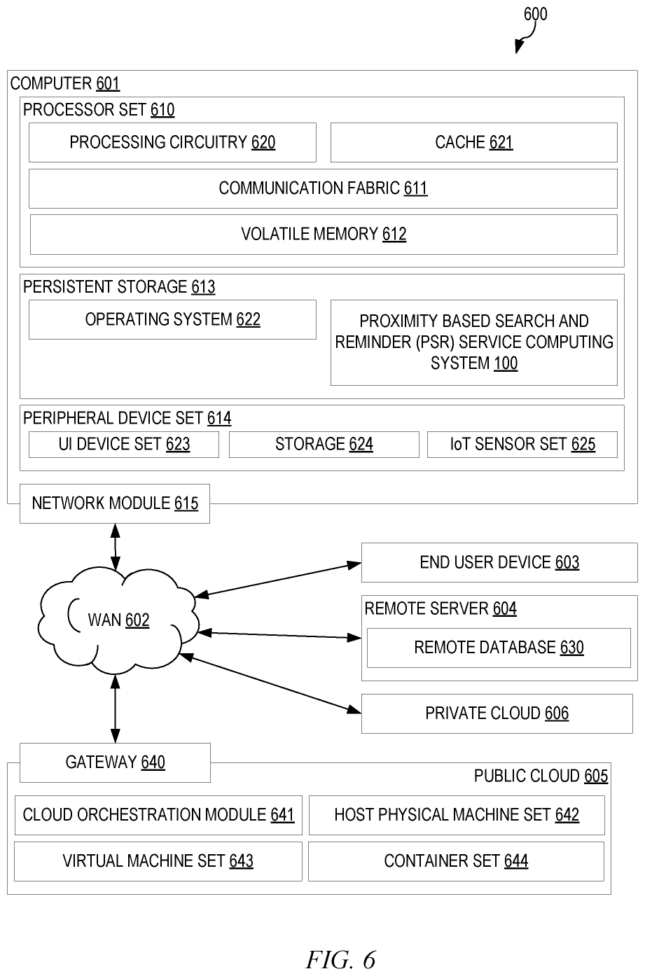

FIG. 6 is an example diagram of a distributed data processing system environment in which aspects of the illustrative embodiments may be implemented and at least some of the computer code involved in performing the inventive methods may be executed. That is, computing environment 600 contains an example of an environment for the execution of at least some of the computer code involved in performing the inventive methods, such as the PSR service computing system 100 of FIG. 1. In addition to block 100, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 200, as identified above), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

Computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

Processor set 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 200 in persistent storage 613.

Communication fabric 611 is the signal conduction paths that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

Persistent storage 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface type operating systems that employ a kernel. The code included in block 200 typically includes at least some of the computer code involved in performing the inventive methods.

Peripheral device set 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

Network module 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

Remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

As shown in FIG. 6, one or more of the computing devices, e.g., computer 601 or remote server 604, may be specifically configured to implement a PSR service computing system 100. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computing device 601 or remote server 604, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described herein above, the implementation of the mechanisms of the illustrative embodiments improves the functionality of the computing device and provides a useful and concrete result that facilitates proximity based search and reminder services for items of interest associated with a user in an a priori and/or dynamic manner so that the user need not have to perform multiple individual searches of item provider computing systems, on a repeated basis, to determine if and when an item of interest is available from a reasonably accessible location within proximity of the user's current location.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

1. A computer-implemented method, comprising:
generating an item listing data structure for a user at least by automatically monitoring, by an artificial intelligence computer model executing on a computing device associated with the user, at least one of a web browser history or application history, via a web browser interface or application interface of the artificial intelligence computer model, for searches for things of interest (ToIs) and automatically populating the item listing data structure with entries corresponding to ToIs in the searches for ToIs, wherein the item listing data structure comprises a plurality of entries for a plurality of ToIs to the user;
generating, for each entry in the at least one entry, corresponding notification criteria specifying characteristics of a ToI and non-ToI criteria for notifying the user of availability of the ToI within a specified proximity of a user location associated with the user, wherein the non-ToI criteria comprises at least one of a maximum travel distance from the user location to a provider of the ToI or a maximum travel time from the user location to the provider of the ToI, and wherein different non-ToI criteria are specified for different ToIs in entries of the item list data structure;
determining, by a location services application executing on the computing device associated with the user, the user location based on a location of the computing device as determined from the location services application;
processing location data corresponding to locations within the specified proximity of the user location to identify at least one provider of ToIs within the specified proximity that match at least one characteristic of an entry of a first ToI in the item listing data structure;
collecting and analyzing provider information for the at least one provider, at least by automatically searching current inventory data of the at least one provider by automatically searching one of a website or an inventory data structure from an inventory control computing system of the at least one provider, to determine whether the at least one provider provides the first ToI and determine whether conditions associated with the at least one provider satisfy the notification criteria for the first ToI specified in the entry corresponding to the first ToI; and
in response to determining that the at least one provider provides the first ToI and that the conditions satisfy the notification criteria, generating an alert notification that is output on the computing device associated with the user, informing the user of the availability of the first ToI within the specified proximity of the user location.

2. (canceled)

3. The computer-implemented method of claim 1, wherein the plurality of ToI comprises at least one of a physical item or product, an activity, or a person of interest.

4-5. (canceled)

6. The computer-implemented method of claim 1, wherein the location associated with the user comprises a predicted location of the computing device associated with the user based on a predefined travel route of the computing device.

7. (canceled)

8. The computer-implemented method of claim 1, wherein the inventory data is obtained from provider computing systems through a Really Simple Syndication (RSS) feed from the provider computing system.

9. The computer-implemented method of claim 1, wherein the notification criteria for the first ToI comprises at least one of a maximum purchase price for the first ToI, a required weather condition for traveling from the location to the at least one provider of the first ToI, or an availability of the user to travel to the at least one provider of the first ToI based on a schedule of other previously scheduled events associated with the user in an electronic calendar of the computing device associated with the user.

10. The computer-implemented method of claim 1, wherein processing location data, collecting and analyzing provider information, and generating alert notifications are performed in real time based on the location associated with the user, as the location associated with the user changes over time.

11. The computer-implemented method of claim 10, wherein performing processing location data, collecting and analyzing provider information, and generating alert notifications in real time comprises:
updating, in real-time, based on a predicted future location of the user, the at least one provider of the first ToIs in the item list data structure that are within the specified proximity from the predicted future location of the user; and
proactively generating and outputting the alert notification to the user computing device prior to the user reaching the predicted future location.

12. The computer-implemented method of claim 9, wherein the notification criteria for the first ToI comprises the availability of the user to travel to the at least one provider of the first ToI, and wherein determining whether conditions associated with the at least one provider satisfy the notification criteria comprises, for the availability of the user to travel to the at least one provider of the first ToI:
estimating a first amount of time required to perform a deviation of a user's current route to a location of the at least one provider;
estimating a second amount of time to obtain the ToI from the at least one provider;
estimating a third amount of time to return to the user's current route;
estimating an arrival time at an original destination of the user's current route based on the first amount of time, second amount of time, and third amount of time;
comparing the estimated arrival time to a desired arrival time; and
determining whether to generate and output the alert notification based on results of the comparison of the estimated arrival time to the desired arrival time.

13. The computer-implemented method of claim 1, wherein the notification criteria for each entry in the item list data structure, corresponding to a ToI in the plurality of ToI, is automatically set based on a predetermined set of default notification criteria corresponding to a type of the corresponding ToI, wherein different types of ToIs have different default notification criteria in the set of default notification criteria.

14. The computer-implemented method of claim 1, wherein generating the item list data structure further comprises generating, for each entry in the item list data structure, a watch list data structure that specifies types of providers that provide a ToI corresponding to the ToI of the entry, and wherein processing location data to identify at least one provider comprises identifying providers within the specified proximity that have types matching the types in the watch lists of the entries in the item list data structure.

15. The computer-implemented method of claim 1, wherein generating and outputting the alert notification to the user computing device comprises modifying a graphical user interface of the user computing device to display a graphical element corresponding to the alert notification.

16. The computer-implemented method of claim 15, wherein the graphical user interface is a graphical map of a geographic region relative to the location associated with the user, and wherein the graphical element comprises a textual message specifying availability of the ToI within the specified proximity of the location associated with the user.

17. The computer-implemented method of claim 16, wherein generating and outputting the alert notification further comprises modifying the graphical map to include a graphical representation of the specified proximity relative to the location associated with the user and a graphical element representing the at least one provider of the first ToI in association with the graphical element corresponding to the alert notification.

18. (canceled)

19. A computer program product comprising a computer readable storage medium having a computer readable program stored therein, wherein the computer readable program, when executed on a data processing system, causes the data processing system to:
generate an item listing data structure for a user at least by automatically monitoring, by an artificial intelligence computer model executing on a computing device associated with the user, at least one of a web browser history or application history, via a web browser interface or application interface of the artificial intelligence computer model, for searches for things of interest (ToIs) and automatically populating the item listing data structure with entries corresponding to ToIs in the searches for ToIs, wherein the item listing data structure comprises a plurality of entries for a plurality of ToIs to the user;
generate, for each entry in the at least one entry, corresponding notification criteria specifying characteristics of a ToI and non-ToI criteria for notifying the user of availability of the ToI within a specified proximity of a user location associated with the user, wherein the non-ToI criteria comprises at least one of a maximum travel distance from the user location to a provider of the ToI or a maximum travel time from the user location to the provider of the ToI, and wherein different non-ToI criteria are specified for different ToIs in entries of the item list data structure;
determine, by a location services application executing on the computing device associated with the user, the user location based on a location of the computing device as determined from the location services application;
process location data corresponding to locations within the specified proximity of the user location to identify at least one provider of ToIs within the specified proximity that match at least one characteristic of an entry of a first ToI in the item listing data structure;
collect and analyze provider information for the at least one provider, at least by automatically searching current inventory data of the at least one provider by automatically searching one of a website or an inventory data structure from an inventory control computing system of the at least one provider, to determine whether the at least one provider provides the first ToI and determine whether conditions associated with the at least one provider satisfy the notification criteria for the first ToI specified in the entry corresponding to the first ToI; and
in response to determining that the at least one provider provides the first ToI and that the conditions satisfy the notification criteria, generate an alert notification that is output on the computing device associated with the user, informing the user of the availability of the first ToI within the specified proximity of the user location.

20. An apparatus comprising:
at least one processor; and
at least one memory coupled to the at least one processor, wherein the at least one memory comprises instructions which, when executed by the at least one processor, cause the at least one processor to:
generate an item listing data structure for a user at least by automatically monitoring, by an artificial intelligence computer model executing on a computing device associated with the user, at least one of a web browser history or application history, via a web browser interface or application interface of the artificial intelligence computer model, for searches for things of interest (ToIs) and automatically populating the item listing data structure with entries corresponding to ToIs in the searches for ToIs, wherein the item listing data structure comprises a plurality of entries for a plurality of ToIs to the user;
generate, for each entry in the at least one entry, corresponding notification criteria specifying characteristics of a ToI and non-ToI criteria for notifying the user of availability of the ToI within a specified proximity of a user location associated with the user, wherein the non-ToI criteria comprises at least one of a maximum travel distance from the user location to a provider of the ToI or a maximum travel time from the user location to the provider of the ToI, and wherein different non-ToI criteria are specified for different ToIs in entries of the item list data structure;
determine, by a location services application executing on the computing device associated with the user, the user location based on a location of the computing device as determined from the location services application;
process location data corresponding to locations within the specified proximity of the user location to identify at least one provider of ToIs within the specified proximity that match at least one characteristic of an entry of a first ToI in the item listing data structure;
collect and analyze provider information for the at least one provider, at least by automatically searching current inventory data of the at least one provider by automatically searching one of a website or an inventory data structure from an inventory control computing system of the at least one provider, to determine whether the at least one provider provides the first ToI and determine whether conditions associated with the at least one provider satisfy the notification criteria for the first ToI specified in the entry corresponding to the first ToI; and
in response to determining that the at least one provider provides the first ToI and that the conditions satisfy the notification criteria, generate an alert notification that is output on the computing device associated with the user, informing the user of the availability of the first ToI within the specified proximity of the user location.

21. The method of claim 1, wherein the non-ToI criteria comprises weather conditions under which notifications are not to be provided to the user.

22. The method of claim 1, wherein there are different default notification criteria for different types of ToIs, and wherein specific notification criteria for specific ToIs in the listing data structure comprises user specified overrides of default notification criteria for at least one entry in the listing data structure.

23. The method of claim 1, further comprising:
determining if the provider has an online purchase computing system;
in response to the provider having an online purchase computing system, providing a notification to the user comprising a user interface for initiating an online purchase of the ToI;
in response to receiving a user selection of the user interface element for initiating the online purchase of the ToI, interfacing with the online purchase computing system to perform an online purchase of the ToI for in-store pickup.

24. The method of claim 1, wherein the alert notification comprises a user selectable option to modify a previously defined navigation route of the user to include an establishment associated with the at least one provider as an intermediate waypoint, wherein the method further comprises:
in response to a user input to the alert notification selecting the user selectable option, modifying the previously defined navigation route in a mapping service application executing on the computing device associated with the user, to include the establishment as an intermediate waypoint to thereby generate a modified navigation route; and
dynamically guiding, via the mapping service application, the user along the modified navigation route to the establishment in response to dynamic changes in the user location.

25. The method of claim 24, further comprising, subsequent to the user location coinciding with a location of the establishment, guiding the user, via the mapping service application, to an original destination of the previously defined navigation route.
